(19) United States
(12) Patent Application Publication
(10) Pub. No.: US 2024/0301930 A1
(43) Pub. Date: Sep. 12, 2024

(54) BALL-SCREW DRIVE FOR AN ACTUATOR ASSEMBLY, AN ACTUATOR ASSEMBLY, AND A METHOD FOR PRODUCING A BALL-SCREW DRIVE

(71) Applicant: ZF Active Safety GmbH, Koblenz (DE)

(72) Inventors: Marco Becker, Oberduerenbach (DE); Michael Weins, Muenstermaifeld (DE); Florian Roessinger, Neuwied (DE); Lukas Madzgalla, Lahnstein (DE)

(21) Appl. No.: 18/589,904

(22) Filed: Feb. 28, 2024

(30) Foreign Application Priority Data
Mar. 7, 2023 (DE) 102023105665.4

(51) Int. Cl. F16D 65/16; F16D 121/04; F16D 125/40; F16H 25/22; F16H 25/24

(52) U.S. Cl. CPC F16D 65/16; F16H 25/2214; F16D 2121/04; F16D 2125/40; F16D 2250/0046; F16H 2025/249

(57) ABSTRACT

A ball-screw drive for an actuator assembly of a vehicle brake is disclosed, comprising a rotatably mounted recirculating ball screw on which a cup-shaped screw nut is mounted. On a circumferential surface of the recirculating ball screw, at least one thread is formed. On the inner surface of the screw nut, a corresponding thread is formed, wherein, in the threads, a plurality of balls are guided in such a way that a rotation of the recirculating ball screw brings about an axial displacement of the screw nut along an axis of rotation of the recirculating ball screw. The screw nut is formed in two parts and has an inner part, in which the thread is formed, and an outer part, on which the circumferential surface of the screw nut is formed. The outer part has protection against corrosion. Furthermore, an actuator assembly and a method for producing a ball-screw drive are indicated.

### CROSS-REFERENCE TO RELATED APPLICATION

This application claims priority to German Priority Application No. 102023105665.4, filed Mar. 7, 2023, the disclosure of which is incorporated herein by reference in its entirety.

### TECHNICAL FIELD

The disclosure relates to a ball-screw drive for an actuator assembly of a vehicle brake, for example for an electromechanically operated brake. The ball-screw drive has a recirculating ball screw, on which a screw nut is mounted. The disclosure further relates to an actuator assembly comprising a ball-screw drive and to a method for producing a ball-screw drive.

### BACKGROUND

The screw nuts used in ball-screw drives are conventionally hardened in order to ensure sufficiently high resistance to the contact pressures occurring in the region of a thread containing the balls.

In an actuator assembly for a vehicle brake, the screw nut forms the brake piston. This means that the screw nut projects in some portions into a gap of a brake caliper in order to place a brake pad on a brake rotor. As a result, the screw nut is subjected to environmental conditions, for example moisture, in particular saline spray water, which promotes corrosion of the screw nut.

It is therefore necessary to provide the screw nut with sufficient protection against corrosion.

In this case, it is disadvantageous that, as a result of the conventional coating processes for applying protection against corrosion, the surface structure is changed after a previous hardening process, whereby the material on the surface becomes softer or porous. As a result, screw nuts which have protection against corrosion are less resistant to contact pressure in the region of the thread. This means that the screw nut wears more quickly.

### SUMMARY

The problem addressed by the disclosure is therefore that of providing a ball-screw drive for an actuator assembly of a vehicle brake which is optimized in terms of the corrosion resistance thereof and the resistance thereof to contact pressure.

This problem is solved according to the disclosure by a ball-screw drive for an actuator assembly of a vehicle brake, comprising a rotatably mounted recirculating ball screw on which a cup-shaped screw nut is mounted. On the circumferential surface of the recirculating ball screw, at least one thread is formed, and on the inner surface of the screw nut, a corresponding thread is formed, wherein, in the threads, a plurality of balls are guided in such a way that a rotation of the recirculating ball screw brings about an axial displacement of the screw nut along an axis of rotation of the recirculating ball screw. The screw nut is formed in two parts and has an inner part, in which the thread is formed, and an outer part, on which the circumferential surface of the screw nut is formed, wherein the outer part has protection against corrosion.

In one exemplary arrangement, only the outer part has protection against corrosion.

As a result of the fact that the outer part has protection against corrosion, the screw nut is sufficiently resistant to environmental conditions when used as a brake piston. At the same time, the surface structure in the region of the thread is not negatively impacted by the protection against corrosion, and therefore there is sufficient resistance to the contact pressures occurring, which are Hertzian contact pressures.

The contact pressures are caused by axial and radial forces when actuating the vehicle brake.

According to one exemplary arrangement, the inner part is open on both sides. For example, the inner part is sleeve shaped. This is advantageous in that, when producing the thread, the inner part is accessible from both sides, whereby a tool for producing the thread does not have to be driven as far into the inner part.

In the case of an inner part which is open on both sides, the outer part is cup shaped, that is to say closed on one side, in order to form the overall cup-shaped geometry of the screw nut.

Due to the cup-shaped outer part, the screw nut is thus sealed in one direction, for example on a side facing towards the brake pad, so that the interior of the screw nut, in which the thread is formed, is protected against the ingress of moisture.

The outer part is for example a deep-drawn part or a cold extruded component. In both cases, the outer part can be produced so as to be cup shaped. A deep-drawn part also has the advantage that it can be produced with a thin wall thickness. This means that the screw nut is optimized in terms of the space requirements thereof.

According to one exemplary arrangement, the outer part is a deep-drawn part and is connected in an interlocking manner to the inner part. This is achieved, for example, in that the outer part is plastically deformed after being placed on the inner part. In this case, there can be a clearance fit between the outer part and the inner part.

In another exemplary arrangement, the outer part is crimped on the inner part.

In an alternative exemplary arrangement, the outer part can be pressed onto the inner part. In this manner, a suitable connection is likewise achieved between the outer part and the inner part.

In one exemplary arrangement, the inner part is a hardened component. This means that the resistance of the screw nut to contact pressures in the region of the thread is additionally increased. Producing the screw nut in two parts prevents the protection against corrosion from diminishing the effect of the hardening process.

For example, the inner part is case hardened.

The end face of the outer part can have a reduced material thickness in the central region thereof. For example, the main introduction of force during an actuation of the ball-screw drive in an actuator assembly takes place via an end-face annular surface of the inner part. The end face of the outer part can thus be formed so as to be thinner in the centre in order to save material.

For example, the outer part has a corrosion protection coating, and in one exemplary arrangement, over the entire outer face or only on the part of the outer face which is exposed after attaching the inner part. The fact that the protection against corrosion is achieved by a coating means that there is a certain degree of flexibility when selecting the material.

According to one exemplary arrangement, the protection against corrosion is formed by ferritic nitrocarburizing.

In the case of a corrosion protection coating applied to the outer part, in one exemplary arrangement, the corrosion protection coating to simultaneously improve the sliding properties of the outer part.

Alternatively, the entire outer part can include a corrosion-resistant material, for example a material which has a higher corrosion resistance than the material of the inner part.

In another alternative, it is conceivable for the protection against corrosion to result from a surface treatment which changes the surface structure of the material.

The problem is further solved by an actuator assembly for a vehicle brake, comprising a brake caliper unit which has a sleeve-shaped portion on which a running surface for the screw nut is formed, and comprising a ball-screw drive according to the disclosure, wherein the screw nut is guided in a non-rotational manner on the running surface of the sleeve-shaped portion by an anti-rotation device. This ensures that a rotation of the recirculating ball screw is translated completely into an axial movement of the screw nut.

The problem is further solved according to the disclosure by a method for producing a ball-screw drive according to the disclosure. In a first method step, an inner part of a screw nut, in which a thread is formed, and an outer part of a screw nut, on which the circumferential surface of the screw nut is formed, are provided. The outer part is provided with a corrosion protection coating in an immersion bath. After the coating, the outer part is connected via the inner part and fixed thereto.

Applying the corrosion protection coating in an immersion bath is particularly simple and quick in terms of production.

The disclosure also relates to a brake piston for a vehicle brake, comprising a ball-screw drive according to the disclosure or a ball-screw drive produced according to the disclosure, wherein the screw nut of the ball-screw drive forms the brake piston.

### BRIEF DESCRIPTION OF DRAWINGS

Further advantages and features of the disclosure can be found in the following description and from the accompanying drawings, to which reference is made. In the drawings,

FIG. 1 shows an actuator assembly according to the disclosure comprising a ball-screw drive according to the disclosure,

FIG. 2 shows a screw nut for a ball-screw drive according to the disclosure, and

FIG. 3 shows the screw nut from FIG. 2 in a perspective sectional view.

### DETAILED DESCRIPTION

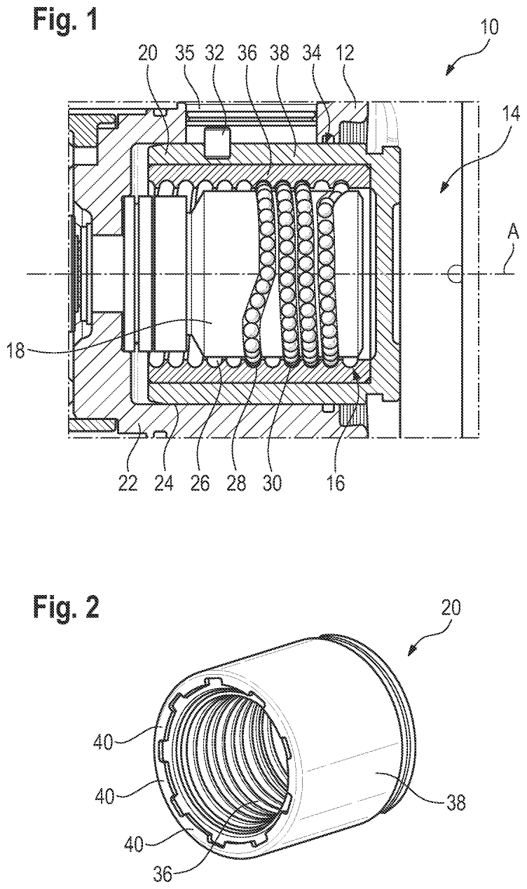

FIG. 1 shows an actuator assembly 10 for a vehicle brake.

The actuator assembly 10 comprises a brake caliper unit 12, in which a gap 14 for a brake rotor is formed. For the sake of simplicity, in FIG. 1, the gap 14 is shown only in part.

Furthermore, the actuator assembly 10 comprises a ball-screw drive 16 having a rotatably mounted recirculating ball screw 18 on which a cup-shaped screw nut 20 is mounted.

In the brake caliper unit 12, a sleeve-shaped portion 22 is formed, on which a running surface 24 for the screw nut 20 is formed.

The screw nut 20 forms a brake piston which is used to place a brake pad on the brake rotor.

An axial displacement of the screw nut 20 is brought about by rotating the recirculating ball-screw 18.

More specifically, on the circumferential surface of the recirculating ball screw 18, at least one thread 26 is formed, and on the inner surface of the screw nut 20, a corresponding thread 28 is formed, wherein, in the threads 26, 28, a plurality of balls 30 are guided in such a way that a rotation of the recirculating ball screw 18 brings about an axial displacement of the screw nut 20 along an axis of rotation of the recirculating ball screw 18.

On the brake caliper unit 12, for example on the running surface 24 of the sleeve-shaped portion 22, the screw nut 20 is guided in a rotationally fixed manner by an anti-rotation device.

For this purpose, in the exemplary arrangement illustrated in FIG. 1, an anti-rotation member 32 is attached to a circumferential surface 34 of the screw nut 20, which member is guided in an axially extending groove 35 in the brake caliper unit 12.

The anti-rotation member 32 is for example a pin.

As can be seen in FIG. 1, the screw nut 20 protrudes into the gap 14 and thus has an outer surface which is exposed in some portions. The exposed outer surface is subjected to environmental conditions such as moisture.

In order to make the screw nut 20 resistant to environmental conditions, protection against corrosion is provided.

As shown in FIG. 1, the screw nut 20 is formed in two parts, and comprises an inner part 36, in which the thread 28 is formed, and an outer part 38, on which the circumferential surface 34 of the screw nut 20 is formed.

The outer part 38, which has an exposed outer surface, has the protection against corrosion.

The inner part 36 is formed without protection against corrosion. Instead, the inner part 36 can be hardened, for example at least in the region of the thread 28.

The protection against corrosion is produced on the outer part 38 for example in the form of a corrosion protection coating. Alternatively, for this purpose, the outer part 38 can include a corrosion-resistant material.

The corrosion protection coating can be applied to the entire outer surface or only to the outer surface of the outer part 38 that is exposed after attaching the inner part 36. It is also conceivable to apply the protection against corrosion only in the region of the outer part 38 which protrudes into the gap 14.

In order to apply the protection against corrosion, the outer part 38 can be immersed in an immersion bath. This process is especially advantageous when the entire outer surface is to be provided with protection against corrosion. Otherwise, the parts that are not to be coated would have to be covered, which increases the complexity.

In the exemplary arrangement according to FIG. 1, the inner part 36 and the outer part 38 are in the form of cold extruded components.

The inner part 36 is open on both sides, for example, has a sleeve-shaped design.

By contrast, the outer part 38 is cup shaped.

The end face of the outer part 38 has a reduced material thickness in the central region. In other words, the end face can be designed to be thinner in the centre in comparison with the region of the circumferential edge, since the force path extends over the circumferential wall of the screw nut 20 during an actuation of the actuator assembly 10.

In order to interconnect the two components, the outer part 38 is pressed onto the inner part 36.

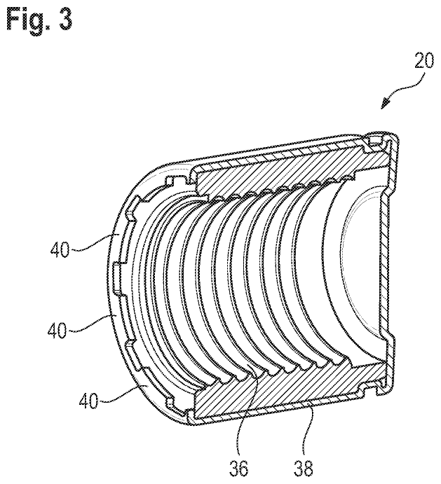

In FIGS. 2 and 3, a screw nut, respectively a brake piston, 20 is shown, which can be used as an alternative to the actuator assembly 10 shown in FIG. 1.

For like structures having like functions which are known from the exemplary arrangement above, the same reference signs are used in the following, and in this respect, reference is made to the preceding explanations, wherein in the following, the differences between the respective exemplary arrangements are described in detail to avoid repetition.

The screw nut 20 shown in FIGS. 2 and 3 differs from the screw nut 20 shown in FIG. 1, for example in terms of the shape of the outer part 38.

The outer part 38 according to FIGS. 2 and 3 is a deep-drawn part.

The outer part 38 being in the form of a deep-drawn part provides alternative possibilities for fixing the outer part 38 to the inner part 36.

More specifically, the outer part 38 can be fixed to the inner part 36 in an interlocking manner.

For this purpose, a plurality of tabs 40 are formed on the outer part 38. These are distributed over the circumference on the open side of the outer part 38.

Before the connection to the inner part 36, the tabs 40 on the outer part 38 extend in the axial direction.

After the outer part 38 has been put over the inner part 36, the tabs 40 are bent inwards into the position shown in FIG. 2, that is to say that the tabs 40 extend radially inwards.

In the case of an interlocking connection, there can be a certain amount of clearance between the inner part 36 and the outer part 38 in contrast to an interference fit.

1. A ball-screw drive for an actuator assembly of a vehicle brake, comprising
a rotatably mounted recirculating ball screw on which a cup-shaped screw nut is mounted,
wherein, on a circumferential surface of the recirculating ball screw, at least one thread is formed, and on an inner surface of the screw nut, a corresponding thread is formed,
wherein, in the threads of the ball screw and the screw nut, a plurality of balls are guided in such a way that a rotation of the recirculating ball screw brings about an axial displacement of the screw nut along an axis of rotation of the recirculating ball screw, at least one friction lining which is attached to a front surface of at least one brake lining carrier plate,
wherein the screw nut is formed in two parts, and comprises an inner part, in which the thread is formed, and an outer part, on which a circumferential surface of the screw nut is formed, and
wherein an outer part has protection against corrosion.

2. The ball-screw drive according to claim 1, wherein the inner part is open on both sides.

3. The ball-screw drive according to claim 1, wherein the outer part is a deep-drawn part or a cold extruded component.

4. The ball-screw drive according to claim 3, wherein the outer part is a deep-drawn part and is connected in an interlocking manner to the inner part.

5. The ball-screw drive according to claim 1, wherein the outer part is pressed onto the inner part.

6. The ball-screw drive according to claim 1, wherein the inner part is a hardened component.

7. The ball-screw drive according to claim 1, wherein the end face of the outer part has a reduced material thickness in the central region thereof.

8. The ball-screw drive according to claim 1, wherein the outer part has a corrosion protection coating.

9. An actuator assembly for a vehicle brake, comprising a brake caliper unit which has a sleeve-shaped portion on which a running surface for a screw nut is formed, and comprising a ball-screw drive according to claim 1, wherein the screw nut is guided in a non-rotational manner on the running surface of the sleeve-shaped portion by an anti-rotation device.

10. A method for producing a ball-screw drive, comprising the following steps:
providing an inner part of a screw nut in which a thread is formed, and an outer part of a screw nut on which the circumferential surface of the screw nut is formed,
providing the outer part with a corrosion protection coating in an immersion bath, and
after the coating, connecting the outer part to the inner part and fixed thereto.

11. A brake piston for a vehicle brake, comprising a ball-screw drive, wherein the ball-screw drive comprises a rotatably mounted recirculating ball screw on which a cup-shaped screw nut is mounted,
wherein, on a circumferential surface of the recirculating ball screw, at least one thread is formed, and on an inner surface of the screw nut, a corresponding thread is formed,
wherein, in the threads of the ball screw and the screw nut, a plurality of balls are guided in such a way that a rotation of the recirculating ball screw brings about an axial displacement of the screw nut along an axis of rotation of the recirculating ball screw, at least one friction lining which is attached to a front surface of at least one brake lining carrier plate,
wherein the screw nut is formed in two parts, and comprises an inner part, in which the thread is formed, and an outer part, on which a circumferential surface of the screw nut is formed, and wherein an outer part has protection against corrosion,
wherein the screw nut of the ball-screw drive forms the brake piston.

12. The ball-screw drive according to claim 2, wherein the outer part is a deep-drawn part or a cold extruded component.

13. The ball-screw drive according to claim 12, wherein the outer part is pressed onto the inner part.

14. The ball-screw drive according to claim 13, wherein the inner part is a hardened component.

15. The ball-screw drive according to claim 13, wherein the end face of the outer part has a reduced material thickness in the central region thereof.

16. The ball-screw drive according to claim 8, wherein the outer part has a corrosion protection coating over an entire outer face or only on a part of the outer face which is exposed after attaching the inner part.
